(19) United States
(12) Patent Application Publication
(10) Pub. No.: US 2009/0171508 A1
(43) Pub. Date: Jul. 2, 2009

(54) REMOTE CONTROL POWER DISTRIBUTION APPARATUS, POWER DISTRIBUTION SYSTEM AND METHOD OF REMOTELY CONTROLLING TYPES OF POWER

(76) Inventor: Nae-II Lee, Gyeonggi-do (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/027,292

(22) Filed: Feb. 7, 2008

(30) Foreign Application Priority Data
Dec. 27, 2007 (KR) 10-2007-0138136

(51) Int. Cl. G05B 15/02

(52) U.S. Cl. 700/286

(57) ABSTRACT

A remote control power distribution apparatus (RCPDA) includes a power distributor and a cluster tool controller (CTC). The power distributor distributes user power to provide a plurality of required types of power to each of a plurality of device modules including at least one transfer module and a plurality of process modules through a first plurality of power lines, and the user power is provided from an external source through a main power line. The CTC, connected to the power distributor and the device modules, remotely controls the required types of power provided to the device modules in real time by using power line communication (PLC).

### CROSS-REFERENCE TO RELATED APPLICATIONS

This application claims priority under 35 USC §119 to Korean Patent Application No. 2007-138136, filed on Dec. 27, 2007 in the Korean Intellectual Property Office (KIPO), the contents of which are herein incorporated by reference in their entirety.

### BACKGROUND OF THE INVENTION

1. Field of the Invention

Example embodiments of the present invention relate to a power distribution apparatus. More particularly, example embodiments of the present invention relate to a power distribution apparatus of semiconductor device using power line communication.

2. Description of the Related Art

Generally, power line communication (PLC) uses pre-installed power lines as communication media, and refers to digital data communication technology that includes transmitting and receiving data using commercial power lines through which power is provided.

The PLC uses a pre-installed power system, and thus using the PLC is more efficient than establishing a new communication network due to reduced costs and reduced system construction time. In addition, the PLC can be applied using household power devices, such as plugs and power cables, and thus users may be more familiar with the PLC than other specified communication techniques. In addition, the PLC is capable of being controlled by a single infrastructure, and the PLC is capable of more easily integrating voice, image, data and other services into a system.

However, the PLC has difficulties in high-capacity communication control and communication range in case of multiple communications because the PLC uses limited power lines as communication media. In addition, the PLC has disadvantages in cases where the amount of data is increased, including low signal processing efficiency due to variable and high attenuation, variable impedance noise, and structural problems in a power line arrangement.

The principles of the PLC are similar to the principles of very high-speed data communication using copper cables, and the PLC uses pre-installed power lines as communication media. User power is provided at a low frequency such as 60 (or 50) Hz. In the PLC, a transmitter transforms communication data into a high-frequency component that is modulated with user power to power lines by using a coupler and transmits the modulated data. A receiver applies a high-pass filter and demodulates the modulated data, and acquires the communication data. The PLC is generally classified as either a low-speed PLC that uses a frequency of 450 kHz for low-speed remote control, or a high-speed PLC that uses a frequency of 2 to 15 MHz for high-speed communication such as Ethernet.

The PLC can be applied to voice communication, a high-speed connection service, home networking, factory automation, and remote meter reading. The PLC is currently applied in home networking, factory automation, etc., which serve as models for others. However, the low-speed PLC and the high-speed PLC are at a beginning stage and have problems that need to be solved, such as radio wave interference due to overload, variable channel characteristics, noise from electric appliances, signal distortion and frequencies overlapping with existing wireless frequency bandwidths.

Generally, a semiconductor manufacturing apparatus includes one or more transfer modules and a plurality of process modules and is integrated into one system. Various kinds of power are provided to the transfer modules and the process modules through a power distributor. When the power distributor is required to be maintained and repaired, an engineer must go to the power distributor in a basement in person, and the engineer manually controls the power distributor for turning off the power distributor to maintain and repair the power distributor. The manual control of the power distributor may increase time for maintaining and repairing, and may not be capable of monitoring the power status of the transfer modules and the process modules. Thus, the manual control of the power distributor may give rise to problems such as system damage and safety accidents in a rapidly changing semiconductor market environment.

### SUMMARY OF THE INVENTION

Accordingly, the present invention is provided to substantially obviate one or more problems due to limitations and disadvantages of the related art.

Some example embodiments of the present invention provide a remote control power distribution apparatus (RCPDA) for remotely controlling types of power provided to semiconductor plasma devices in real time through power line communication (PLC).

Some example embodiments of the present invention also provide a power distribution system (PDS) of a semiconductor manufacturing apparatus including the RCPDA.

Some example embodiments of the present invention still also provide a method of remotely controlling types of power provided to a plurality of device modules.

In some example embodiments of the present invention, an RCPDA includes a power distributor and a cluster tool controller (CTC). The power distributor distributes user power to provide a plurality of required types of power to each of a plurality of device modules including at least one transfer module and a plurality of process modules, and the user power is provided from an external source. The CTC, coupled to the power distributor and the device modules, remotely control the required types of power provided to each of the plurality of device modules from the power distributor in real time by using PLC.

In some embodiments, the power distributor may include a first PLC modem, and the CTC may include a second PLC modem. The first and second PLC modems may perform the PLC.

In some embodiments, the power distributor and the CTC may be connected to each other through a power line, and the CTC and the device modules may be connected through a local area network (LAN) or Ethernet.

In some embodiments, the PLC may use a carrier sense multiple access/arbitration by message priority (CSMA/AMP) algorithm. The PLC may employ control area network (CAN) communication.

In some embodiments, the CTC may remotely control the required types of power by using a software program. The software program may correspond to a graphical user interface remote control system (GUIRCS). The GUIRCS may perform power distribution control of the device modules. The GUIRCS may monitor required types of power provided to each of the device modules. The power distributor distributes user power to provide a plurality of required types of power to each of a plurality of device modules including at least one transfer module and a plurality of process modules through a first plurality of power lines, and the user power is provided from an external source through a main power line. The CTC, connected to the power distributor and the device modules, remotely controls in real time the required types of power by PLC.

In some other example embodiments of the present invention, an RCPDA includes a power distributor and a CTC. The power distributor distributes user power to provide a plurality of required types of power to each of a plurality of device modules including at least one transfer module and a plurality of process modules through a first plurality of power lines, and the user power is provided from an external source through a main power line. The CTC, connected to the power distributor and the device modules, remotely controls in real time the required types of power by PLC.

In some other example embodiments of the present invention, an RCPDA includes a power distributor and a CTC may be connected to the device modules through a third plurality of power lines.

In some embodiments, the power distributor may include an input unit that receives the user power, a distributing unit that is connected to the input unit and distributes the user power, an output unit that is connected to the distributing unit and outputs the distributed user power and a control unit that includes a first PLC mode for performing the PLC with the CTC, and controls the input unit, the distributing unit and the output unit to provide the required types of power.

The CTC may include a second PLC modem for performing the PLC with the first PLC modem. Each of the device modules may include a third PLC modem for providing information and the power status for each of the required types of power by performing the PLC with the CTC.

In some other example embodiments of the present invention, a PDS of a semiconductor manufacturing apparatus includes a plurality of device modules, a power distributor, and a CTC. The plurality of device modules includes at least one transfer module and a plurality of process modules. The power distributor distributes user power to provide a plurality of required types of power to each of the device modules, and the user power is provided from an external source through a main power line. The CTC, coupled to the power distributor and the device modules, remotely controls in real time the required types of power by PLC.

In some other example embodiments of the present invention, in a method of remotely controlling types of power provided to a plurality of device modules, user power from an external source is distributed. A plurality of required types of power is provided to each of the device modules from the distributed power through a plurality of power lines. The required types of power are controlled remotely and in real time by using PLC.

Accordingly, example embodiments of the present invention may remotely control and monitor required types of power provided to device modules by using a software program corresponding to a GUIRCS.

### BRIEF DESCRIPTION OF THE DRAWINGS

The above and other features and advantages of the invention will become readily apparent by reference to the following detailed description when considered in conjunction with the accompanying drawings wherein:

FIG. 1 is a block diagram illustrating a remote control power distribution apparatus (RCPDA) according to an example embodiment of the present invention;

FIG. 2 illustrates an arrangement of a power distributor and a cluster tool controller (CTC) in an actual engineering field;

FIGS. 3A and 3B illustrate device modules controlled by a graphical user interface remote control system (GUIRCS) and the power status of required types of power provided to each of the device modules;

FIG. 4 is a block diagram illustrating an RCDPA and a power distribution system of a semiconductor manufacturing apparatus including the RCDPA according to another example embodiment of the present invention;

FIG. 5 is a flow chart illustrating a method of remotely controlling types of power.

### DESCRIPTION OF THE EMBODIMENTS

Embodiments of the present invention now will be described more fully with reference to the accompanying drawings, in which embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a remote control power distribution apparatus (RCPDA) according to an example embodiment of the present invention.

Referring to FIG. 1, an RCPDA 100 according to an example embodiment of the present invention includes a power distributor 10 and a cluster tool controller (CTC) 20.

The power distributor 10 distributes user power provided from an external source through a main power line 40 to provide a plurality of required types of power to each of a plurality of device modules 31, 33, and 35 through a first plurality of power lines 50. The device modules 31, 33, and 35 may be included in a semiconductor plasma apparatus, and the device modules 31, 33, and 35 may include at least one transfer module 31 and a plurality of process modules 33 and 35.

Although not illustrated, the CTC 20 may include a master scheduler and a module scheduler, and the CTC 20 may transmit control commands for each of the device modules 31, 33, and 35 from the master scheduler to the module scheduler in response to process recipe. The module scheduler may control operating scheduling of each of the device modules 31, 33, and 35 in response to the control commands.

The CTC 20 may be connected to the power distributor 10 through a second power line 60, and the CTC 20 may be connected to the device modules 31, 33, and 35 through a network 70 such as a local area network (LAN) or Ethernet. The CTC 20 may receive information and the power status for each of the required types of power with respect to the device modules 31, 33, and 35 through the network 70. The CTC 20 remotely controls in real time the required types of power provided to the device modules 31, 33, and 35 from the power distributor 10 by using power line communication (PLC) based on the information and power status. The power distributor 10 includes a first PLC modem 15, and the CTC 20 includes a second PLC modem 25 for remotely controlling the required types of power provided to the device modules 31, 33, and 35 from the power distributor 10. A carrier sense multiple access/arbitration by message priority (CSMA/AMP) algorithm is used in the PLC between the CTC 20 and the power distributor 10 for minimizing noise from semiconductor plasma devices such as a chemical vapor deposition (CVD) device and an etcher. The CSMA/AMP algorithm is a robust communication control. The CSMA/AMP algorithm is applied to the PLC between the CTC 20 and the power distributor 10 for processing data based on message priority in case of message collision when data is transmitted from the device modules 31, 33, and 35 to the CTC 20. In addition, a control area network (CAN) communication scheme may also be applied to the PLC between the CTC 20 and the power distributor 10.

The CTC 20 may remotely control the required types of power provided to the device modules 31, 33, and 35 from the power distributor 10 by using a software program corresponding to a graphical user interface remote control system (GUIRCS).

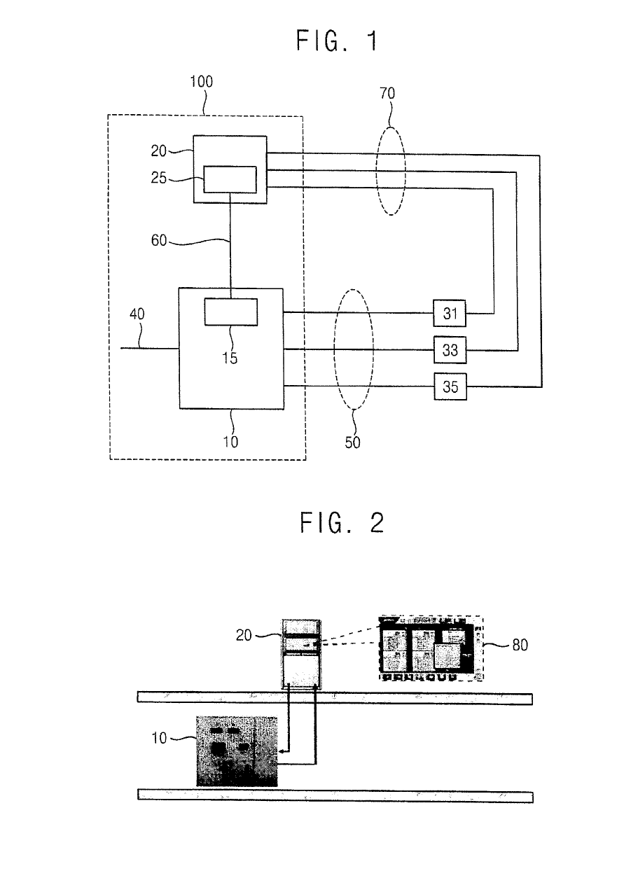

FIG. 2 illustrates an arrangement of the power distributor 10 and the CTC 20 in an actual engineering field.

Referring to FIG. 2, the power distributor 10 may be located in a basement, and the CTC 20 may be located on the ground. The CTC 20 may remotely control the power distributor 10 in real time by using a GUIRCS 80 through the PLC.

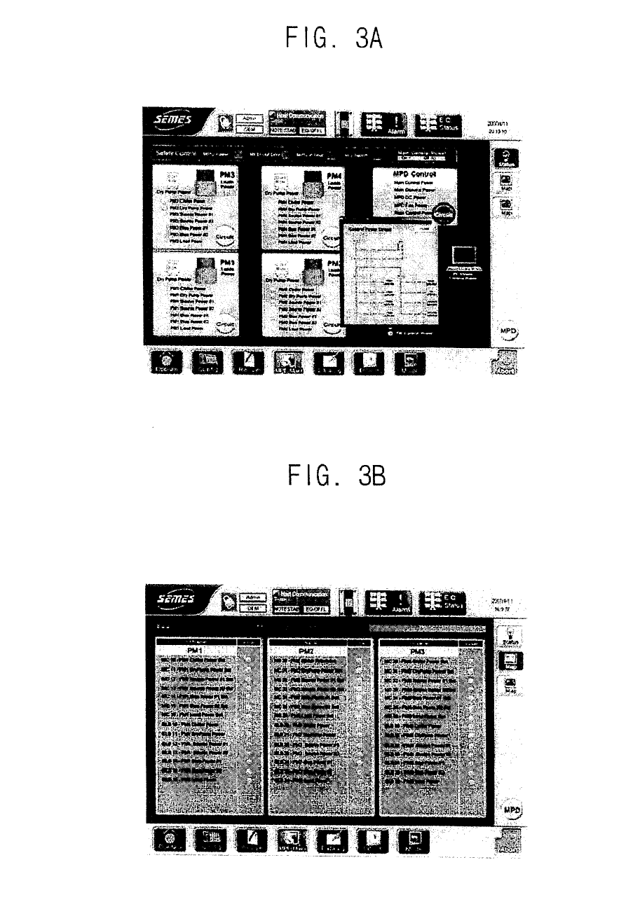

FIGS. 3A and 3B illustrate the device modules 31, 33 and 35 controlled by the GUIRCS 80 and the power status of the required types of power provided to each of the device modules 31, 33 and 35. Power distribution control of the device modules 31, 33 and 35 may be performed and monitored in real time through the GUIRCS 80 to determine whether the required types of power are being properly provided to each of the device modules 31, 33 and 35.

Various amounts of the required types of power are provided from the power distributor 10 to the device modules 31, 33, and 35. The RCPDA 100 according to an example embodiment of the present invention controls the various required types of power in real time by using the software program, i.e., the GUIRCS 80. The RCPDA 100 is capable of robust control of the semiconductor plasma device, ensuring safety, and reducing time for maintaining and repairing the semiconductor plasma device. In addition, the RCPDA 100 uses pre-installed power lines in a conventional power distribution apparatus, and RCPDA 100 may perform remote controlling in the manually-controlled power distribution apparatus without an extra device.

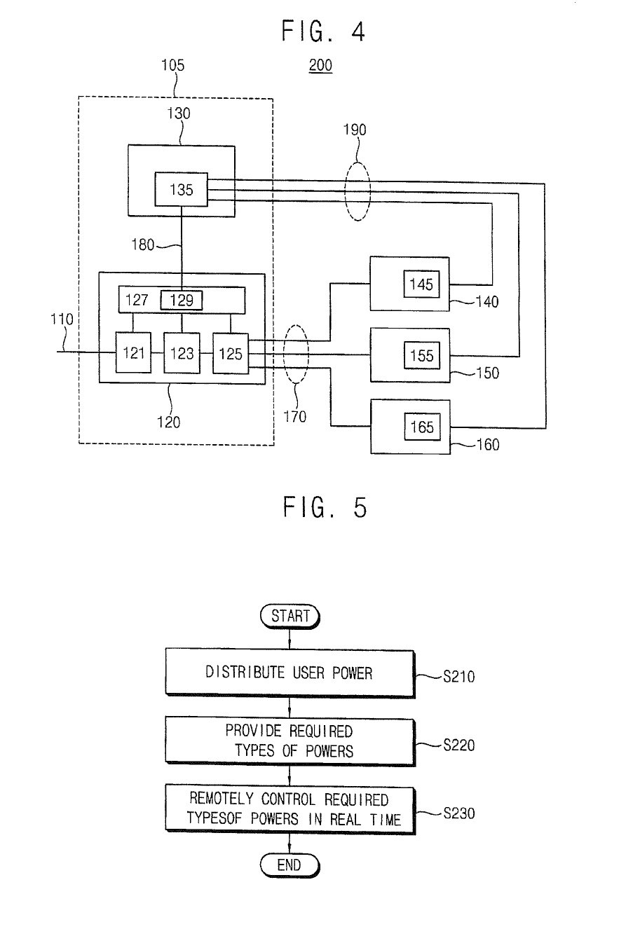

FIG. 4 is a block diagram illustrating an RCDPA and a power distribution system (PDS) of a semiconductor manufacturing apparatus including the RCDPA according to another example embodiment of the present invention.

Referring to FIG. 4, an RCDPA 105 includes a power distributor 120, and a CTC 135, and a PDS 200 includes the RCDPA 105 and a plurality of device modules 140, 150 and 160.

The power distributor 120 distributes user power provided from an external source through a main power line 110 to provide a plurality of required types of power to each of a plurality of device modules 140, 150 and 160 through a first plurality of power lines 170. The CTC 130 may be connected to the power distributor 120 through a second power line 180, and the CTC 130 may be connected to the device modules 140, 150 and 160 through a third plurality of power lines 190. The CTC 130 remotely controls in real time the required types of power provided to the device modules 140, 150 and 160 from the power distributor 120.

The power distributor 120 includes an input unit 121, a distributing unit 123, an output unit 125, and a control unit 127 including a first PLC modem 129. The input unit 121 receives the user power. The distributing unit 123 distributes the user power. The output unit 125 outputs the distributed user power. The control unit 127 performs the PLC with the CTC 130 through the first PLC modem 129, and controls the input unit 121, the distributing unit 123 and the output unit 125 to remotely control the required types of power provided to the device modules 140, 150 and 160 in real time.

The CTC 130 includes a second PLC modem 135. The device modules 140, 150 and 160 may include corresponding third PLC modems 145, 155 and 165. The CTC 130 remotely controls in real time the required types of power provided to the device modules 140, 150 and 160 from the power distributor 10 by using PLC. A CSMA/AMP algorithm is used in the PLC between the CTC 130 and the power distributor 120 and between the CTC 130 and the device modules 140, 150 and 160 for minimizing noise from semiconductor plasma devices such as a CVD device and an etcher. In addition, a CAN communication scheme may also be applied to the PLC between the CTC 130 and the power distributor 120 and between the CTC 130 and the device modules 140, 150 and 160.

The device modules 140, 150 and 160 may include at least one transfer module 140 and a plurality of process modules 150 and 160. Although not illustrated, the CTC 130 may remotely control the required types of power provided to the device modules 140, 150 and 160 from the power distributor 120 by using a software program corresponding to the GUIRCS of FIGS. 3A and 3B. That is, the CTC 130 may perform power distribution control of the device modules 140, 150 and 160 in real time and monitor to determine whether or not the required types of power are being properly provided to each of the device modules 140, 150 and 160 by using the GUIRCS 80 of FIGS. 3A and 3B.

Various kinds of the required power are provided from the power distributor 120 to the device modules 140, 150 and 160 as illustrated in FIGS. 3A and 3B. The RCPDA 105 according to an example embodiment of the present invention controls the various required types of power in real time by using the software program, i.e., the GUIRCS 80. The RCPDA 105 is capable of robust control of the semiconductor plasma device, ensuring safety, and reducing time for maintaining and repairing the semiconductor plasma device. In addition, the RCPDA 105 and the PDS 200 uses pre-installed power lines in the conventional power distribution apparatus, and may perform remote controlling in the manually-controlled power distribution apparatus without an extra device.

FIG. 5 is a flow chart illustrating a method of remotely controlling types of power provided to a plurality of device modules according to example embodiment of the present invention.

Referring to FIGS. 4 and 5, in a method of remotely controlling types of power provided to a plurality of device modules, user power from an external source is distributed (step S210). A plurality of required types of power is provided to each of a plurality of device modules 140, 150 and 160 through a first plurality of power lines 170 (step S220). Here, the required types of power are needed by the device modules 140, 150 and 160 and provided from the distributed user power. Then, the required types of power provided to the device modules 140, 150 and 160 are remotely controlled in real time through the PLC. In step S230, the required types of power provided to the device modules 140, 150 and 160 may be remotely controlled by using a software program corresponding to the GUIRCS. A detailed description about a method of remotely controlling types of power provided to a plurality of device modules is substantially similar to a description about the RCPDAs with reference to FIGS. 1 and 4, and thus will be omitted.

Hereinafter, there will be a description about a CAN communication scheme that may be applied to an RCPDA, a PDS including the RCDPA and a method of remotely controlling types of power provided to a plurality of device modules according to example embodiments of the present invention.

The CAN communication is a serial communication standard of the International Organization of Standardization (ISO), and includes a physical layer and a data link layer as standards among the seven layers of the Open Systems Interconnection (OSI) model. The CAN standard is a mature standard, is a hardware description protocol, uses simple transmission lines, and has excellent error handling characteristics.

In the CAN, an asynchronous serial bus is used, and a message identifier is used rather than an address. The message identifier opens and arranges priority and data at a node. The lowest message identifier has the highest priority. The CAN is a non-destructive arbitration system that uses a CSMA collision detection scheme. That is, an arbitration system for preventing collision exists in the CAN. In addition, a plurality of masters exist in the CAN, and the CAN performs precise error detection and error handling through broadcasting. The CAN is primarily used as an industry automation application. A CAN bus includes dominance corresponding to logic “1” and recessiveness corresponding to logic “0”. In the CAN, an output becomes logic “1” when two buffers include logic “1”, respectively, as an AND logic gate. The CAN has a function of bit shifting. A receiving part has difficulty in finding an appropriate time for signal analysis, when consecutive logic “1” or consecutive logic “0” are included in an input signal. In the CAN, a signal having a reverse bit is input for timing of the signal analysis, when the input signal includes consecutive logic “1” or consecutive logic “0”. The CAN communication is applied to example embodiments of the present invention because of the above-mentioned CAN characteristics.

According to the present invention, a power distributor is remotely controlled in real time for providing and distributing types of power to semiconductor plasma devices through PLC in real time without an extra communication network, and thus a power distribution system may be easily constructed, and time for maintaining and repairing the power distributor may be reduced. In addition, power distribution control of the semiconductor plasma devices may be performed and monitored in real time by using a GUIRCS, and thus, control reliability may be acquired by two-way communication. In addition, competitiveness of the hardware may be ensured by remotely controlling the semiconductor plasma devices, ensuring safety and increasing easiness through controlling power distribution.

While the example embodiments of the present invention and their advantages have been described in detail, it should be understood that various changes, substitutions and alterations may be made herein without departing from the scope of the invention.

What is claimed is:

1. A remote control power distribution apparatus (RCPDA) comprising:
a power distributor configured to distribute user power to provide a plurality of required types of power to each of a plurality of device modules including at least one transfer module and a plurality of process modules, the user power being provided from an external source; and
a cluster tool controller (CTC), coupled to the power distributor and the device modules, and configured to remotely control in real time the required types of power provided to each of the plurality of device modules from the power distributor by using power line communication (PLC).

2. The RCPDA of claim 1, wherein the power distributor includes a first PLC modem, and the CTC includes a second PLC modem, the first and second PLC modems performing the PLC.

3. The RCPDA of claim 1, wherein the power distributor and the CTC are connected to each other through a power line, and wherein the CTC and the device modules are connected through a local area network (LAN) or Ethernet.

4. The RCPDA of claim 1, wherein the PLC uses a carrier sense multiple access/arbitration by message priority (CSMA/AMP) algorithm.

5. The RCPDA of claim 1, wherein the PLC employs control area network (CAN) communication.

6. The RCPDA of claim 1, wherein the CTC remotely controls the required types of power by using a software program.

7. The RCPDA of claim 6, wherein the software program corresponds to a graphical user interface remote control system (GUIRCS).

8. The RCPDA of claim 7, wherein the device modules are semiconductor plasma devices.

9. The RCPDA of claim 7, wherein the GUIRCS performs power distribution control of the device modules.

10. The RCPDA of claim 7, wherein the GUIRCS monitors required types of power provided to each of the device modules.

11. An RCPDA comprising:
a power distributor configured to distribute user power to provide a plurality of required types of power to each of a plurality of device modules including at least one transfer module and a plurality of process modules through a first plurality of power lines, the user power being provided from an external source through a main power line; and
a CTC, connected to the power distributor and the device modules, and configured to remotely control in real time the required types of power by PLC.

12. The RCPDA of claim 11, wherein the CTC is connected to the power distributor through a second power line and wherein the CTC is connected to the device modules through a third plurality of power lines.

13. The RCPDA of claim 12, wherein the power distributor comprises:
an input unit that receives the user power;
a distributing unit that is connected to the input unit and distributes the user power;
an output unit that is connected to the distributing unit and outputs the distributed user power; and
a control unit that includes a first PLC mode for performing the PLC with the CTC, and controls the input unit, the distributing unit and the output unit to provide the required types of power.

14. The RCPDA of claim 13, wherein the CTC comprises a second PLC modem for performing the PLC with the first PLC modem.

15. The RCPDA of claim 14, wherein each of the device modules comprises a third PLC modem for providing information and the power status for each of the required types of power by performing the PLC with the CTC.

16. The RCPDA of claim 11, wherein the PLC uses a CSMA/AMP algorithm.

17. The RCPDA of claim 11, wherein the PLC employs CAN communication.

18. The RCPDA of claim 11, wherein the CTC remotely controls the required types of power by using a software program corresponding to a GUIRCS.

19. A power distribution system (PDS) of a semiconductor manufacturing apparatus, the PDS comprising:
a plurality of device modules including at least one transfer module and a plurality of process modules;
a power distributor configured to distribute user power to provide a plurality of required types of power to each of the device modules, the user power being provided from an external source through a main power line; and
a CTC, coupled to the power distributor and the device modules, and configured to remotely control in real time the required types of power by PLC.

20. The PDS of claim 19, wherein the power distributor comprises:
an input unit that receives the user power;
a distributing unit that is connected to the input unit and distributes the user power;
an output unit that is connected to the distributing unit and output the distributed user power; and
a control unit that includes a first PLC mode for performing the PLC with the CTC, and controls the input unit, the distributing unit and the output unit to provide the required types of power.

21. The PDS of claim 20, wherein the CTC comprises a second PLC modem for performing the PLC with the first PLC modem and wherein each of the device modules comprises a third PLC modem for providing information and the power status for each of the required types of power by performing the PLC with the CTC.

22. The PDS of claim 21, wherein the CTC remotely controls the required types of power by using a software program corresponding to a GUIRCS.

23. A method of remotely controlling types of power provided to a plurality of device modules, the method comprising:
distributing user power provided from an external source;
providing a plurality of required types of power to each of the device modules from the distributed power through a plurality of power lines; and
remotely controlling the required types of power in real time by using PLC.

24. The method of claim 23, wherein the required types of power are remotely controlled based on information and the power status for each of the required types of power.

25. The method of claim 23, wherein the required types of power are remotely controlled by using a software program corresponding to a GUIRCS.
